(19) United States
(12) Patent Application Publication
(10) Pub. No.: US 2010/0248044 A1
(43) Pub. Date: Sep. 30, 2010

(54) ON BOARD GENERATION OF N2 FOR FUEL CELLS USING A MEMBRANE

(76) Inventors: Tony M.K. Thampan, Bear, DE (US); Robert Benesch, Wilmington, DE (US)

Correspondence Address: AIR LIQUIDE USA LLC;Intellectual Property, 2700 POST OAK BOULEVARD, SUITE 1800, HOUSTON, TX, 77056, US

(21) Appl. No.: 12/416,105

(22) Filed: Mar. 31, 2009

(51) Int. Cl. H01M 8/06; H01M 8/04

(52) U.S. Cl. 429/413; 429/429; 429/513

(57) ABSTRACT

A PEMFC is operated in an operation mode in which a membrane-based humidifier is used to transfer moisture from a moisture-laden exhaust stream to the dry air feed and in a shutdown mode in which the membrane-based humidifier is used to permeate moisture and oxygen from the moisture-laden exhaust stream to provide a N₂-rich exhaust for purging of the anode.

### CROSS-REFERENCE TO RELATED APPLICATIONS

None.

### BACKGROUND

Proton Exchange Membrane Fuel Cells (PEMFCs) are energy conversion devices that offer significant advantages over conventional motive technology. They include the benefits of internal combustion engines (high power density, ability to be fueled) and batteries (modular nature, no moving parts). Additionally with the use of hydrogen, PEMFCs only emit water. Thus, due to the advantages, automakers have begun to deploy fuel cell vehicles.

However, among the challenges facing PEMFCs is durability. It has been reported that residual H₂ remaining in a fuel cell after shut down reacts with air, resulting in carbon corrosion that can significantly diminish PEMFC lifetime (H. Tang et al., J. Power Sources, 158 1306-1312 (2006); and C Reiser et al., Electrochem Solid State Lett 8 (6) A272-276 (2005)). An example of the damage due to start/stop effects is shown in FIGS. 1a and 1b, where the effect of start/stop cycles on fuel cell polarization performance is shown (S. Y Lee et al, J Electrochem 154 (2) B194 (2007)). FIG. 1a shows the performance of the fuel cell in terms of voltage vs. current density where no purging of the fuel cell was performed, while FIG. 1b shows the performance where purging with air was performed.

One proposed solution includes the use of a purge to remove H₂ in the anode chamber. For example, WO 2006/071223 A1 describes the use of a purge gas to inert the anode and cathode of a PEM fuel cell during start up and shut down.

It is also known that phosphoric acid fuel cell technology involves utilizing N₂ for purging during start up and shut down situations (Handbook of Fuel Cells, Vol. 4, Catalyst Studies and Coating Technologies—pg 827, Editors Vielstich, Lamm and Gasteiger).

In another example U.S. Pat. No. 6,858,336 B2 describes the use of an air compressor to increase the air flow through the anode chamber to decrease the space velocity resulting in a minimization of the degradation effects on the fuel cell. As shown in FIG. 2, the data represented by curve J is an uncontrolled shut down resulting in air diffusing into the anode chamber and resulting in 20% loss (0.2 out 1 V) after only 200 starts. The data represented by curve J shows an improvement observed by utilizing a purge gas (N₂). The data shown by curve K shows an improvement observed by using an air compressor to purge H₂ from the anode. While use of the air compressor increases the space velocity (decreases residence time) and thus minimizes membrane electrode assembly (MEA) damage, it however decreases reliability of the system.

It has also been reported that it is necessary to minimize ice/frost formation in the fuel cell which is detrimental to lifetime fuel cell performance (J Hou et al., Electrochem. Solid State Lett 10 B11 (2007); and S. Ge, CY Wang, Electrochimica Acta 52 4825 (2007)). This can be done utilizing a dry purge stream that purges the cell (E. Cho et. al., J Electrochem. 151 (5) A661 (2004)). However, it is not clear that previous work provides a fully satisfactory means for accomplishing this that is practical for transportation applications.

### SUMMARY

There is disclosed an improved fuel cell system including: a dry air feed, a source of compressed Hydrogen, a bypass conduit, a membrane-based humidifier having an evaporation side and a condensation side, a fuel cell having a cathode side, an anode side, and a moisture-laden exhaust outlet, a fuel cell, a vent, a plurality of valves, and a controller. The fuel cell is adapted to react air from said dry air feed and Hydrogen from said compressed Hydrogen source to produce electricity and produce a moisture-laden exhaust stream at said moisture-laden exhaust outlet. The moisture-laden exhaust outlet is in fluid communication with said condensation side and said membrane-based humidifier is adapted to permeate some of the moisture in the moisture-laden exhaust stream from said condensation side to said evaporation side to produce a dried exhaust stream from said condensation side. The controller is adapted to actuate said plurality of valves in an operation mode and a startup/shutdown mode. In said operation mode, said controller actuates at least some of said plurality of valves to: a) place said dry air feed, said evaporation side, and said cathode side in fluid communication such that said dry feed is humidified by the moisture permeated from the moisture-laden exhaust stream and is fed to said cathode side; b) place said source of compressed Hydrogen and said anode side in fluid communication; and c) place said condensation side and said vent in fluid communication such that the dried exhaust stream is vented. In said startup/shutdown mode, said controller actuates at least some of said plurality of valves to: a) place said dry air feed, said bypass conduit, and said cathode side in fluid communication; b) isolate said evaporation side from said dry air feed; c) isolate said anode side from said source of compressed Hydrogen; d) place said condensation side and said evaporation side in fluid communication; e) direct a first portion of the dried exhaust stream from said condensation side to said evaporation side to sweep moisture therefrom and vent the moisture at said vent; and f) direct a second portion of the dried exhaust stream from said condensation side to said anode side.

There is also disclosed a method of initiating operation of the above fuel cell system that includes the following steps. The above disclosed fuel cell system is provided in an inactive state. The controller is used to place the fuel cell system in the startup/shutdown mode.

There is also disclosed a method of shutting down operation of the above fuel cell system that includes the following steps. The above disclosed fuel cell system is provided. The fuel cell system is operated in the operation mode. Operation of the fuel cell system in operation mode is discontinued. The controller is used to place the fuel cell system in the startup/shutdown mode.

There is also disclosed a method of operating a fuel cell system comprising a dry air feed, a source of compressed Hydrogen, a bypass conduit, a membrane-based humidifier having an evaporation side and a condensation side, a fuel cell having a cathode side, an anode side, and a moisture-laden exhaust outlet, a vent, and a plurality of valves. The method includes the following steps. The dry air feed is directed to the evaporation side where the dry air feed is humidified to provide a humidified feed. The humidified feed is directed to the cathode side. Hydrogen is directed from the source of compressed Hydrogen to the anode side. Oxygen from the compressed humidified feed is reacted with the Hydrogen at the fuel cell to produce electricity and a moisture-laden exhaust stream. The moisture-laden exhaust stream is directed from the fuel cell to the condensation side where moisture permeates through the membrane of the humidifier to the evaporation side to provide the humidification of the dry air feed and to provide a dried exhaust stream. The dried exhaust stream is vented.

The above fuel cell system and methods may include one or more of the following aspects.
the system or method further includes an expander coupled to a compressor, wherein:
   in said operation mode, the controller actuates at least some of said plurality of valves to:
      place said compressor in fluid communication between said evaporation side and said cathode side and such that the humidified feed is compressed;
      place said expander in fluid communication between said condensation side and said vent;
   said expander transfers energy to said compressor resulting from expansion of the dried exhaust stream from the condensation side; and
   in said startup/shutdown mode, said controller actuates at least some of said plurality of valves to:
      place said compressor in fluid communication between said bypass conduit and said cathode side such that the dry air feed is compressed;
      place said expander in fluid communication between said condensation side and said anode side such that the dried exhaust stream is directed to said anode side.
the system or method further includes a first exhaust stream conduit in fluid communication between said moisture-laden exhaust outlet and said condensation side and a second exhaust stream conduit in fluid communication with said moisture-laden exhaust outlet, wherein:
   during said operation mode, said controller actuates at least some of said plurality of valves to place said second exhaust stream conduit in fluid communication between said moisture-laden exhaust outlet and said expander; and
   during said startup/shutdown mode, said controller actuates at least some of said plurality of valves to vent said second exhaust stream conduit.
the membrane-based humidifier is a hollow fiber membrane-based humidifier.
the membrane of said membrane-based humidifier preferentially permeates O₂ over N₂.
the method further includes the steps of:
   providing a compressor coupled to an expander;
   compressing the humidified feed with the compressor before the humidified feed is directed to the cathode side; and
   expanding the dried exhaust stream with the expander before the dried exhaust stream is vented to produce energy, wherein the energy is transferred to the compressor.
the method, wherein:
   the moisture-laden exhaust stream is split into first and second moisture-laden exhaust streams and the first moisture-laden exhaust stream is directed to the fuel cell in said step of directing the moisture-laden exhaust stream from the fuel cell; and
   the second moisture-laden exhaust stream is also expanded by the expander.
the method further includes the steps of:
   discontinuing the directing of the dry air feed to the evaporation side thereby preventing humidification of the dry air feed at the evaporation side;
   discontinuing the directing of the Hydrogen from the source of compressed Hydrogen to the anode side;
   discontinuing the venting of the dried exhaust stream.
   directing the dry air feed to the cathode side;
   directing a first portion of the dried exhaust stream to the evaporation side to sweep moisture therefrom and venting the combined moisture and dried exhaust stream; and
   directing a second portion of the dried exhaust stream to the anode side.
the method further includes the steps of:
   providing a compressor coupled to an expander;
   compressing the dry air feed with the compressor before the dry air feed is directed to the cathode side; and
   expanding the second portion of the dried exhaust stream with the expander before the second portion of the dried exhaust stream is directed to the anode side thereby producing energy, wherein the energy is transferred to the compressor.
the method, wherein:
   the moisture-laden exhaust stream is split into first and second moisture-laden exhaust streams and the first moisture-laden exhaust stream is directed to the fuel cell in said step of directing the moisture-laden exhaust stream from the fuel cell; and
   the second moisture-laden exhaust stream is vented.
the membrane-based humidifier is a hollow fiber membrane-based humidifier.
the membrane of said membrane-based humidifier preferentially permeates O₂ over N₂.

### BRIEF DESCRIPTION OF THE DRAWINGS

For a further understanding of the nature and objects of the present invention, reference should be made to the following detailed description, taken in conjunction with the accompanying drawings, in which like elements are given the same or analogous reference numbers and wherein:

FIG. 1a is a graph showing the performance of a fuel cell in terms of voltage vs. current density where no purging of the fuel cell is performed.

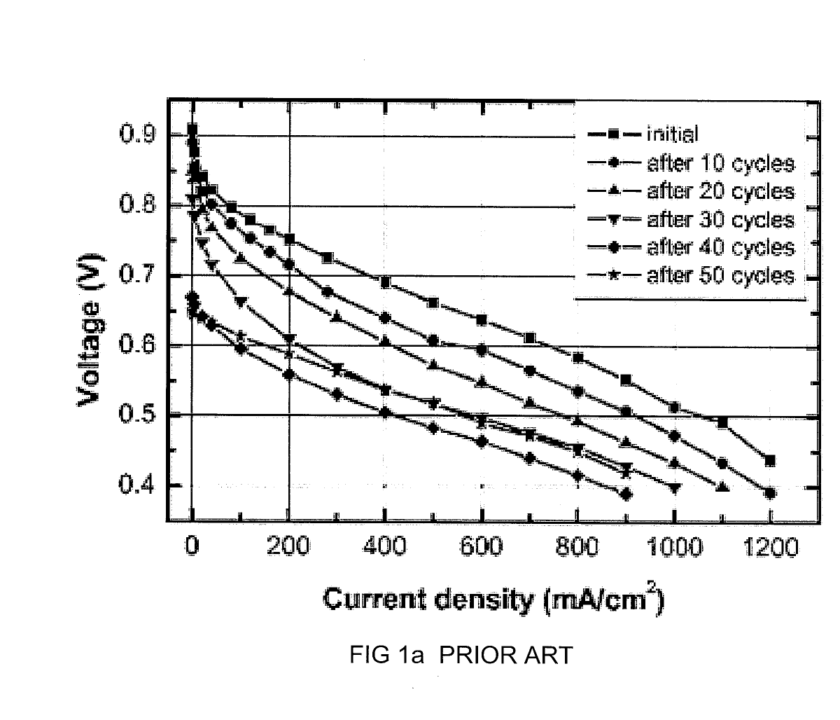

FIG. 1b is a graph showing the performance of a fuel cell in terms of voltage vs. current density where purging with air is performed.

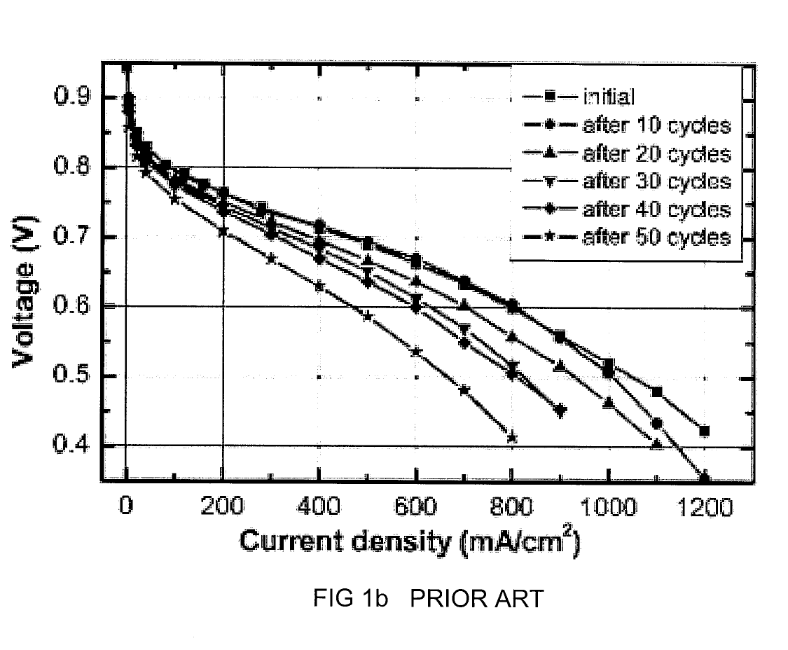

FIG. 2 is a graph showing voltage loss by a fuel cell vs. the number of starts.

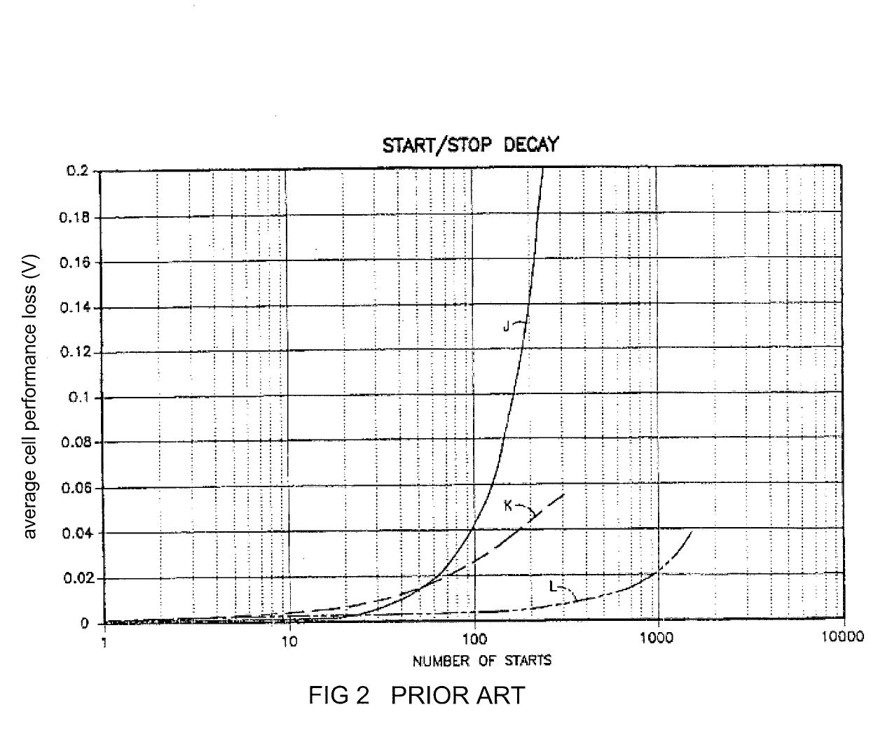

FIG. 3 is a schematic of the disclosed system.

### DESCRIPTION OF PREFERRED EMBODIMENTS

During normal operation (operation mode) of the PEMFC, a humidifier is utilized to humidify a cathode feed stream. It does this by transferring moisture from a cathode exhaust stream to the cathode feed stream utilizing a membrane.

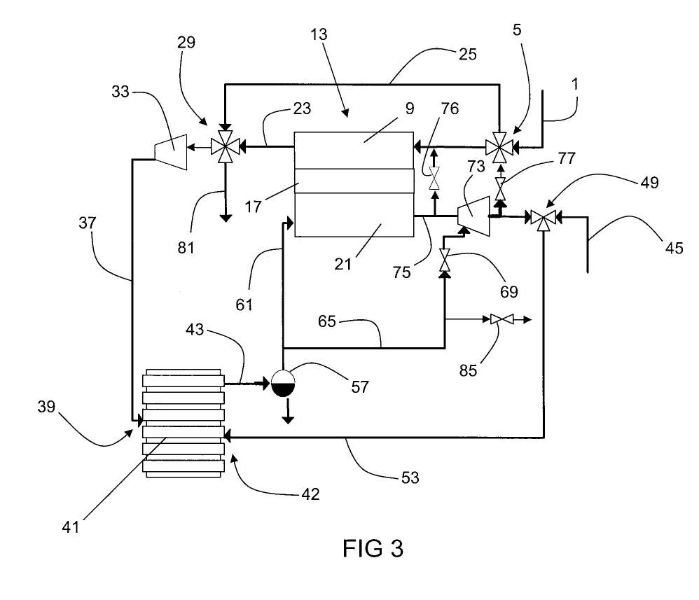

As best illustrated in FIG. 3, during the operation mode a controller (not shown) closes shutoff valves 85, 76 and opens shutoff valves 69, 77. The controller also actuates four-way valve 5 into a first position to allow the dry air feed 1 to pass into the evaporation side 9 of the membrane-based humidifier 13. Depending upon the degree of water permeation through the membrane 17 from the moisture-laden exhaust stream 61 at the condensation side 21 to the evaporation side 9, the humidified feed 23 exits the humidifier 13 at a higher temperature and higher dewpoint. The membrane 17 may be any membrane known in the art that preferentially permeates O₂ over N₂.

The controller also actuates four-way valve 29 into a first position allowing the humidified stream 23 to be fed into a compressor 33, where it is compressed to a pressure appropriate for operation of the fuel cell 41. The compressed stream 37 is then fed to the cathode side 39 of fuel cell 41.

The reaction in the PEMFC produces water and electricity as follows:

Anode: 2H₂→4H⁺+4e-

Cathode: 4H⁺+O₂→2H₂O

A moisture-laden exhaust stream 43 leaves the moisture-laden exhaust outlet 44 of fuel cell 41 and enters water trap 57 which removes liquid water. The remaining moisture-laden exhaust is split into first and second moisture-laden exhaust streams 61, 65. The first stream 61 is fed to the condensation side 21 of the humidifier 13 while the second stream 65 bypasses the humidifier 13.

Moisture/heat from the first stream 61 permeates/transfers through the membrane 17 from the condensation side 21 to the evaporation side 9. Due to the lower pressure of the feed stream 1, a relatively low amount of O₂ is transferred from the feed stream 1 to the first stream 61. The now-dried exhaust stream 61 leaves with a lower dewpoint and at a lower temperature. Both the dried exhaust stream 61 exiting the condensation side 21 and stream 65 are expanded at the expander 73 (or turbine). Because it is coupled to the compressor 33, the expander 73 transfers the energy produced from the expansion to the compressor 33 to lower any energy requirement of compressor 33. The expanded combination of the dried exhaust and moisture-laden exhaust is then directed through shutoff valve 77, four-way valve 5, bypass conduit 25, and four-way valve 29 to vent 81.

Also during operation mode, the controller actuates three-way valve into a first position allowing a H₂ stream 45 to be fed to the anode side 42 of the fuel cell 41 via three-way valve 49 and conduit 53. Of course, during normal operation, valve 85 is closed position. Also, the expanded combination of dried exhaust and moisture-laden exhaust is prevented from entering three-way valve 49 and closed shutoff valve 76.

Now operation during shut down (shutdown mode) will be described. The shutdown process may be performed for a normal shutdown or for an emergency shutdown in case a H₂ leak is detected during operation of the fuel cell in order to quickly purge the cell of H₂ and inert the PEMFC enclosure.

During the shutdown mode, the controller closes shutoff valves 77, 69 and opens shutoff valves 76, 85. The controller also actuates four-way valve 5 into a second position allowing the dry air feed 1 to pass through bypass 25. In this manner, it bypasses the humidifier 13, does not enter the evaporation side 9 of humidifier 13 and is not humidified. The controller also actuates four-way valve 29 into a second position allowing the dry air to be fed, via compressor 33, to the cathode side 39 of the fuel cell 41.

The dry air fed to the cathode side 39 picks up residual moisture from the fuel cell 41. The now moisture-laden exhaust stream 43 exits the moisture-laden outlet 44 and is directed into the water trap 57 where liquid water is removed. The moisture-laden exhaust is split into first and second moisture-laden exhaust streams 61, 65. Stream 65 is directed to vent via valve 85.

The first moisture-laden exhaust stream 61 is fed to the condensation side 21 of the humidifier 13. The membrane allows O₂ and moisture in stream 61 to selectively permeate over N₂ through the membrane 17 from the condensation side 21 to the evaporation side 9. This results in a dried N₂-rich exhaust stream leaving the condensation side 21 of the humidifier 13.

A portion of the dry N₂-rich exhaust stream is diverted through orifice 75 and valve 76 into the evaporation side 9 where it where it provides sufficient pressure to purge the permeated O₂ and moisture from evaporation side 9 and out vent 81 via four-way valve 29. The portion of the dried exhaust stream not diverted through orifice 75 is expanded at expander 73 to produce energy for transfer to the compressor 33. The expanded dried exhaust stream is directed through three-way valve 49 to the anode side 42 via conduit 53. This allows the anode side 42 to be purged with an N₂ enriched gas and minimizes damage to the membrane electrode assembly (MEA) due to oxidation/corrosion. Because H₂ is an extremely flammable gas and forms a combustible mixture in the range 4% to 74.20%, the anode side 42 purge helps to prevent formation of an explosive H₂ atmosphere.

Now operation during startup (startup mode) will be described. In the startup mode, the shutdown mode process can be repeated to purge the cell of O₂ before introduction of H₂.

During the startup mode, shutoff valves 77, 69 are in a closed position and shutoff valves 76, 85 are in an open position. The four-way valve 5 is in its second position allowing the dry air feed 1 to pass through bypass 25. In this manner, it bypasses the humidifier 13, does not enter the evaporation side 9 of humidifier 13 and is not humidified. Four-way valve 29 is in its second position allowing the dry air to be fed, via compressor 33, to the cathode side 39 of the fuel cell 41.

Although the shutdown mode is preferably performed for a time sufficient to remove moisture from the fuel cell 41, the dry air fed to the cathode side 39 may pick up some residual moisture. The now moisture-laden exhaust stream 43 exits the moisture-laden outlet 44 and is directed into the water trap 57 where liquid water is removed. The moisture-laden exhaust is split into first and second moisture-laden exhaust streams 61, 65. Stream 65 is directed to vent via valve 85.

The first moisture-laden exhaust stream 61 is fed to the condensation side 21 of the humidifier 13. The membrane allows O₂ and moisture in stream 61 to selectively permeate over N₂ through the membrane 17 from the condensation side 21 to the evaporation side 9. This results in a dried N₂-rich exhaust stream leaving the condensation side 21 of the humidifier 13.

A portion of the dried N₂-rich exhaust stream is diverted through orifice 75 and valve 76 into the evaporation side 9 where it where it provides sufficient pressure to purge the permeated O₂ and moisture from evaporation side 9 and out vent 81 via four-way valve 29. The portion of the dried exhaust stream not diverted through orifice 75 is expanded at expander 73 to produce energy for transfer to the compressor 33. The expanded dried exhaust stream is directed through three-way valve 49 to the anode side 42 via conduit 53. As discussed above, this allows any O₂ at the anode 42 to be purged with an N₂ enriched gas before H₂ is introduced to the anode side 42.

Preferred processes and apparatus for practicing the present invention have been described. It will be understood and readily apparent to the skilled artisan that many changes and modifications may be made to the above-described embodiments without departing from the spirit and the scope of the present invention. The foregoing is illustrative only and that other embodiments of the integrated processes and apparatus may be employed without departing from the true scope of the invention defined in the following claims.

What is claimed is:

1. An improved fuel cell system, comprising:
a dry air feed;
a source of compressed Hydrogen;
a bypass conduit;
a membrane-based humidifier having an evaporation side and a condensation side;
a fuel cell having a cathode side, an anode side, and a moisture-laden exhaust outlet, said fuel cell being adapted to react air from said dry air feed and Hydrogen from said compressed Hydrogen source to produce electricity and produce a moisture-laden exhaust stream at said moisture-laden exhaust outlet, wherein said moisture-laden exhaust outlet is in fluid communication with said condensation side and said membrane-based humidifier is adapted to permeate some of the moisture in the moisture-laden exhaust stream from said condensation side to said evaporation side to produce a dried exhaust stream from said condensation side;
a vent;
a plurality of valves; and
a controller adapted to actuate said plurality of valves in an operation mode and a startup/shutdown mode, wherein:
in said operation mode, said controller actuates at least some of said plurality of valves to:
place said dry air feed, said evaporation side, and said cathode side in fluid communication such that said dry feed is humidified by the moisture permeated from the moisture-laden exhaust stream and is fed to said cathode side;
place said source of compressed Hydrogen and said anode side in fluid communication;
place said condensation side and said vent in fluid communication such that the dried exhaust stream is vented; and
in said startup/shutdown mode, said controller actuates at least some of said plurality of valves to:
place said dry air feed, said bypass conduit, and said cathode side in fluid communication;
isolate said evaporation side from said dry air feed;
isolate said anode side from said source of compressed Hydrogen;
place said condensation side and said evaporation side in fluid communication;
direct a first portion of the dried exhaust stream from said condensation side to said evaporation side to sweep moisture therefrom and vent the moisture at said vent; and
direct a second portion of the dried exhaust stream from said condensation side to said anode side.

2. The system of claim 1, further comprising an expander coupled to a compressor, wherein:
in said operation mode, the controller actuates at least some of said plurality of valves to:
place said compressor in fluid communication between said evaporation side and said cathode side and such that the humidified feed is compressed;
place said expander in fluid communication between said condensation side and said vent;
said expander transfers energy to said compressor resulting from expansion of the dried exhaust stream from the condensation side; and
in said startup/shutdown mode, said controller actuates at least some of said plurality of valves to:
place said compressor in fluid communication between said bypass conduit and said cathode side such that the dry air feed is compressed;
place said expander in fluid communication between said condensation side and said anode side such that the dried exhaust stream is directed to said anode side.

3. The system of claim 2, further comprising a first exhaust stream conduit in fluid communication between said moisture-laden exhaust outlet and said condensation side and a second exhaust stream conduit in fluid communication with said moisture-laden exhaust outlet, wherein:
during said operation mode, said controller actuates at least some of said plurality of valves to place said second exhaust stream conduit in fluid communication between said moisture-laden exhaust outlet and said expander; and
during said startup/shutdown mode, said controller actuates at least some of said plurality of valves to vent said second exhaust stream conduit.

4. The fuel cell system of claim 1, wherein said membrane-based humidifier is a hollow fiber membrane-based humidifier.

5. The fuel cell system of claim 1, wherein said membrane of said membrane-based humidifier preferentially permeates O₂ over N₂.

6. A method of initiating operation of the fuel cell system of claim 1, comprising the steps of:
providing the fuel cell system of claim 1 in an inactive state;
using the controller to place the fuel cell system in the startup/shutdown mode.

7. A method of shutting down operation of the fuel cell system of claim 1, comprising the steps of:
providing the fuel cell system of claim 1;
operating the fuel cell system in operation mode;
discontinuing operation of the fuel cell system in operation mode; and
using the controller to place the fuel cell system in the startup/shutdown mode.

8. A method of operating a fuel cell system comprising a dry air feed, a source of compressed Hydrogen, a bypass conduit, a membrane-based humidifier having an evaporation side and a condensation side, a fuel cell having a cathode side, an anode side, and a moisture-laden exhaust outlet, a vent, and a plurality of valves, said method comprising the steps of:
directing the dry air feed to the evaporation side where the dry air feed is humidified to provide a humidified feed;
directing the humidified feed to the cathode side;
directing Hydrogen from the source of compressed Hydrogen to the anode side;
reacting oxygen from the compressed humidified feed with the Hydrogen to produce electricity and a moisture-laden exhaust stream;
directing the moisture-laden exhaust stream from the fuel cell to the condensation side where moisture permeates through the membrane of the humidifier to the evaporation side to provide the humidification of the dry air feed and to provide a dried exhaust stream;
venting the dried exhaust stream.

9. The method of claim 8, further comprising the steps of:
providing a compressor coupled to an expander;
compressing the humidified feed with the compressor before the humidified feed is directed to the cathode side; and
expanding the dried exhaust stream with the expander before the dried exhaust stream is vented to produce energy, wherein the energy is transferred to the compressor.

10. The method of claim 8, wherein:
the moisture-laden exhaust stream is split into first and second moisture-laden exhaust streams and the first moisture-laden exhaust stream is directed to the fuel cell in said step of directing the moisture-laden exhaust stream from the fuel cell; and
the second moisture-laden exhaust stream is also expanded by the expander.

11. The method of claim 8, further comprising said steps of:
discontinuing the directing of the dry air feed to the evaporation side thereby preventing humidification of the dry air feed at the evaporation side;
discontinuing the directing of the Hydrogen from the source of compressed Hydrogen to the anode side;
discontinuing the venting of the dried exhaust stream.
directing the dry air feed to the cathode side;
directing a first portion of the dried exhaust stream to the evaporation side to sweep moisture therefrom and venting the combined moisture and dried exhaust stream; and
directing a second portion of the dried exhaust stream to the anode side.

12. The method of claim 11, further comprising the steps of:
providing a compressor coupled to an expander;
compressing the dry air feed with the compressor before the dry air feed is directed to the cathode side; and
expanding the second portion of the dried exhaust stream with the expander before the second portion of the dried exhaust stream is directed to the anode side thereby producing energy, wherein the energy is transferred to the compressor.

13. The method of claim 12, wherein:
the moisture-laden exhaust stream is split into first and second moisture-laden exhaust streams and the first moisture-laden exhaust stream is directed to the fuel cell in said step of directing the moisture-laden exhaust stream from the fuel cell; and
the second moisture-laden exhaust stream is vented.

14. The method of claim 8, wherein said membrane-based humidifier is a hollow fiber membrane-based humidifier.

15. The method of claim 8, wherein said membrane of said membrane-based humidifier preferentially permeates O₂ over N₂.
